(19) United States
(12) Patent Application Publication
(10) Pub. No.: US 2012/0290444 A1
(43) Pub. Date: Nov. 15, 2012

(54) Golf Course Foodstuff Ordering System and Method of the Same

(76) Inventor: Gord Nelson, Calgary (CA)

(21) Appl. No.: 13/104,230

(22) Filed: May 10, 2011

(51) Int. Cl. G06Q 30/00

(52) U.S. Cl. 705/27.1

(57) ABSTRACT

A golf course food ordering system reduces the period of delay in the play of golf on a golf course created by golfers ordering food and/or beverage between the play of two holes. The system provides an electric menu kiosk at the start of a hole that allows golfers to place a food and/or beverage order for receipt upon completing play of the hole. Orders placed utilizing the menu kiosk are transmitted over a communication network to an order receipt unit located at a food facility on the golf course. The received order is filled and ready for receipt by golfers upon completion of the hole.

### FIELD OF THE INVENTION

The present invention relates generally to ordering food and/or beverages at golf courses, and more particularly, relating to the ordering of food and/or beverages at a golf course while out on the golf course and from an electric menu kiosk such that the order is completed and is ready to be received upon completion of a hole.

### BACKGROUND OF THE INVENTION

During the play of a round of golf it is common at the turn (after completing the ninth-hole and before beginning the tenth-hole) for golfers to take an intermission and order food and/or beverages from a food facility located at the golf course. Conventionally the food facility is located at a club house or a halfway house that is located on the golf course at some location between the ninth green and the tenth tee box.

A golfer desiring to place a food and/or beverage order is required to physically visit the food facility to place and receive his/her order. On a busy day, this system and method creates a delay in the play on the golf course as result of the golfers wait for their orders to be taken and filled prior to resuming play. This delay is undesirable to both the golf course and the golfers.

Accordingly, there is a need for a new system and method which reduces the delay created in the play of golf on the golf course as a result of golfers purchasing food and/or beverages during a round of golf from a food facility.

### SUMMARY OF THE INVENTION

Embodiments of the present invention addresses this need by providing golf course food ordering and system and method that utilizes a period of time required to complete the play of one or more holes to fill an order that is placed by a golfer before the start of play of the one or more holes.

Embodiments of the present invention also provide an electronic menu kiosk and an electronic order receipt unit in communication with the electronic menu kiosk to receive and process orders entered and submitted through the electronic menu kiosk

Embodiments of the present invention further provide for locating the electronic menu kiosk at a location on the golf course, such as, for example the tee box of the ninth-hole and for locating the electronic order receipt unit at a food facility locate at a location remote from the location of the electronic menu kiosk.

To achieve these and other advantages, in general, in one aspect, a golf course foodstuff ordering system includes a menu kiosk located on a golf course at a location remotely from a food facility located on the golf course, and an order receipt unit located at the food facility. The menu kiosk has a means for displaying menu items offered by the food facility, a means for receiving a menu item selection from a user, a means for generating a foodstuff order including one or more menu item selections, and a means for transmitting the foodstuff order. The order receipt unit has a means for receiving from the menu kiosk the order and a means for printing the order at the food facility.

In general, in another aspect, a method of ordering foodstuff at a golf course is provided. The method including the steps of displaying a menu by a menu displaying means of a menu kiosk that is located on the golf course at a location that is remote from a food facility of the golf course, the menu including one or more menu items; receiving one or more menu item selections by a means for receiving menu item selections of the menu kiosk; generating a foodstuff order including the one or more menu item selections by a means for generating a foodstuff order of the menu kiosk; transmitting the foodstuff order over a communication network from the menu kiosk to an order receipt unit located at the food facility; receiving the foodstuff order over the communication network by an order receiving means of the order receipt unit and from the menu kiosk; printing the foodstuff order by a printing means for printing a foodstuff order of the order receipt unit; and processing the foodstuff order in a time period that permits receipt of the one or more menu item selections subsequent completion of play of a designated golf hole of the golf course.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a diagrammatic illustration of a golf course and a system in accordance with the principles of the invention;

FIG. 2 is a block diagram of a menu kiosk terminal according to an embodiment of the invention;

FIG. 3 is a block diagram of an order receipt terminal according to an embodiment of the invention;

FIG. 4 is a diagrammatic illustration of a display screen of a graphical user interface and user input in accordance with the present invention;

FIG. 5 is a diagrammatic illustration of a menu kiosk including a decorative housing simulating the appearance of a boulder;

FIG. 6 is a block diagram of one system for providing power to the menu kiosk of the present invention;

FIG. 7 is a block diagram of another system for providing power to the menu kiosk of the present invention;

FIG. 8 is a process flow diagram illustrating a method of entering and submitting an food and/or beverage order according to an embodiment of the invention; and

FIG. 9 is a process flow diagram illustrating a method of completing a submitted food and/or beverage order according to an embodiment of the invention.

### DETAILED DESCRIPTION OF THE INVENTION

Systems and methods in accordance with the present invention allow golfers at a golf course to place a food and/or beverage order with a hospitality facility located on the golf course from remote terminal. For example, a golfer using a remote terminal located at a tee-box of a golf hole on the golf course may place a food and/or beverage order with the hospitality facility while waiting to tee-off. The food and/or beverage order is then retrieved by the golfer at a later time from the hospitality facility, e.g. once the golfer completes play of the particular golf hole.

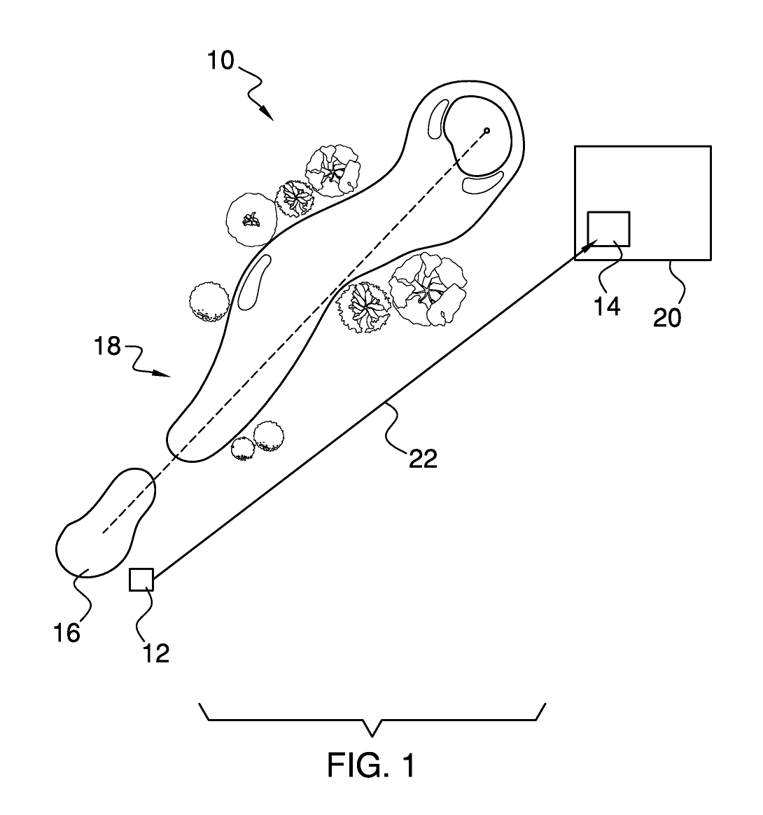

Referring to FIG. 1, there is diagrammatically illustrated a remote golf course ordering system 10 according to embodiments of the invention. The remote golf course ordering system 10 comprises a menu kiosk terminal 12 and an order receipt terminal 14. The menu kiosk terminal 12 is representatively, located at a tee box 16 of a desired golf course hole 18 and the order receipt terminal 14 is located at a hospitality facility 20, such as a club house, snack shack or the like of the golf course. While the menu kiosk terminal 12 is depicted here at the tee box 16, the menu kiosk terminal may be located at any other location on the golf course a desired. Further, while only a single menu kiosk terminal 12 and a single order receipt terminal 14 are illustrated and described herein, the system may be expanded to include multiple menu kiosk terminals 12 and order receipt terminals 14 as required and/or desired.

The remote golf course ordering system 10 enables one or more golfers to place and submit a food and/or beverage order while on the golf course, for example, from the tee box 16 of the ninth hole 18 to the hospitality facility 20 such that the food and/or beverage order is ready for pickup and purchase when the one or more golfers have completed play of the hole. In doing so, a food and/or beverage order is entered into the menu kiosk terminal 12 through interaction with a graphical user interface and then is submitted through a communication link 22 to the order receipt unit 14, where the food and/or beverage order is received and processed as will be described in more detail below.

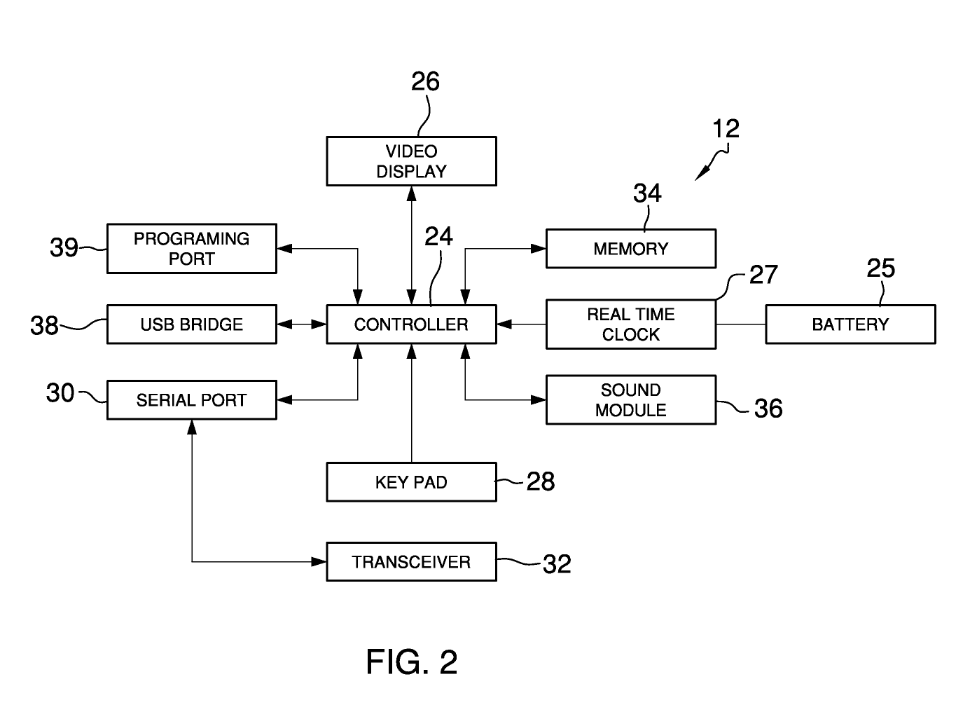

Referring now to FIG. 2, there is illustrated a block diagram of the menu kiosk terminal 12 in accordance with an embodiment of the invention. As illustrated, the menu kiosk terminal 12 generally comprises a kiosk controller 24, a video display with touch screen capabilities 26, a key pad 28, network/communication interface 30, a radio frequency transceiver 32, a memory device 34, a sound module 36, a universal serial bus (USB) interface 38 and optionally a programming port 39.

Kiosk controller 24 is any suitable programmable logic controller or computer processing unit. For example, kiosk controller 24 may be Microchip 18F4680 8-bit microcontroller. A battery 25 powered real time clock (RTC) 27 is connected to the kiosk controller. Video display 26 is operatively connected to the kiosk controller 24. Video display 26 is preferably a touch screen video monitor for displaying video graphics and receiving user inputs. However, a touch screen is not necessary since user inputs can be made through keypad 28.

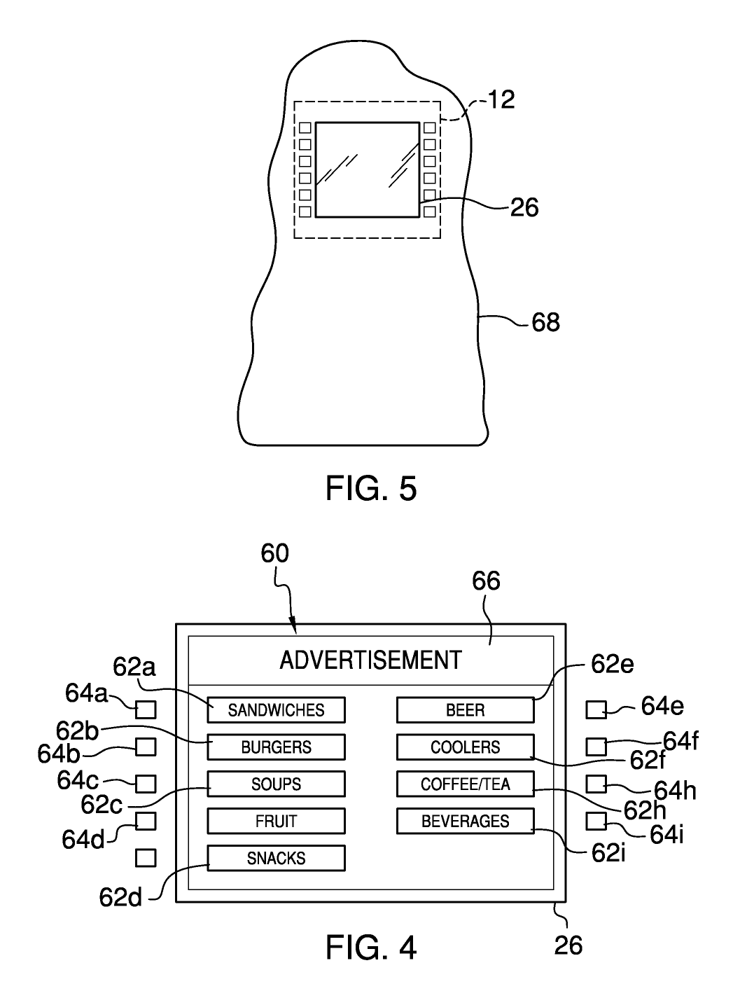

Keypad 28 preferably comprises an eight-button entry device having each button located relative to the video display 26 and associated with one or more graphics, such as menu selections, displayed on video display 26 (best seen in FIG. 4). However, keypad 28 may be a conventional alpha-numeric or numeric key entry device. Transceiver 32 is connected to the kiosk controller 24 via network/communication interface 30.

Memory device 34 is operatively connected to kiosk controller and stores operational information such as one or more software programs that facilitates the operation of the menu kiosk terminal 12, menu item data, advertising data, etc. Sound module 36 is operatively connected to the controller 24 and provides audio output to a user such as alert sounds, feedback sounds, music, video sound, etc. USB interface 38 permits connecting an external device to the menu kiosk terminal 12 for loading data onto memory device 34 and/or internal memory of the kiosk controller 24. For example, menu data, video, advertising data or any other data and/or programming requirements.

In embodiments, transceiver 32 may be replaced by a cellular telephone communication device, a satellite communication device, modem or any other device capable of transmitting and receiving data on a communication network. For example, network/communication interface 30 may be comprise any computer bus and the transceiver 32 may be an Ethernet device through which kiosk controller 24 may be connected to the internet, a wide area network, a local area network or any other computer network upon which data may be transmitted.

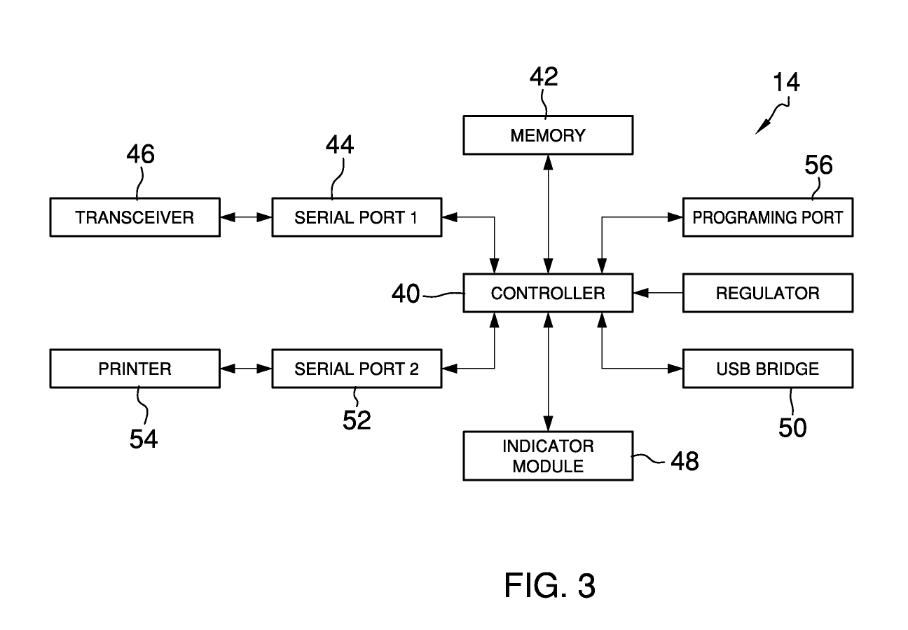

Referring now to FIG. 3, there is illustrated a block diagram of the order receipt terminal 14 in accordance with an embodiment of the invention. As illustrated, the order receipt terminal 14 generally comprises an order receipt terminal controller 40, memory device 42, a network/communication interface 44, a radio frequency transceiver 46, a visual status indicator module 48, a universal serial bus (USB) interface 50, a peripheral interface 52, a printer 54 and a programming interface 56.

Order receipt terminal controller 40 is any suitable programmable logic controller or computer processing unit. For example, controller 40 may be an integrated circuit containing a processing core, memory and programmable input/output peripherals. Memory device 42 is operatively connected to the order receipt terminal controller 40 and stores operational information such as one or more software programs that facilitates the operation of the order receipt terminal 14. Network/communication interface 44 operatively connects order receipt terminal controller 40 and the radio frequency transceiver 46. Visual status indicator module 48 is operatively connected to order receipt terminal controller 40 and provides visual indication to employees of the hospitality facility 20 of the operating status of the order receipt terminal 14. In an embodiment, the visual status indicator 48 includes a plurality of colored light emitting element, such as light emitting diodes (LED) which indicate the operating status, e.g. a red LED indicates an error, a green LED indicates operating correctly, and an amber LED indicates communicating with a menu kiosk terminal 12.

USB interface 50 permits connecting an external device to the order receipt terminal 14 for loading data onto memory device 42 and/or internal memory of the order receipt terminal controller 40. For example, menu data, video, advertising data or any other data and/or programming requirements. Peripheral interface 52 operative connects the order receipt terminal controller 40 and a printer 54. Alternatively or in addition to the printer 54 a video display monitor (not shown) and/or a sound module (not shown) may be connected to a peripheral interface, such as interface 52.

Similarly, in embodiments, transceiver 46 may be replaced by a cellular telephone communication device, a satellite communication device, modem or any other device capable of transmitting and receiving data on a communication network. For example, network/communication interface 44 may be comprise any computer bus and the transceiver 46 may be an Ethernet device through which kiosk controller 40 may be connected to the internet, a wide area network, a local area network or any other computer network upon which data may be transmitted.

In the embodiment illustrated, transceiver 32 and 46 are paired to solely communicate with one another on data communication network 22, herein illustrated as a wireless radio connection, for the transmission of data between the menu kiosk terminal 12 and the order receipt terminal 14 in the processing of food and/or beverage order, for programming the menu kiosk terminal, etc.

Now referring to FIG. 4, there is diagrammatically illustrated an exemplary graphical user interface 60 displayed on video display 26 and representatively including various food and beverage main menu choices 62a-62i and which is representative of an initial screen depicted to a user. Key pad input 28 is representatively depicted as including a series of key pad buttons 64a-64i located along opposite sides of the video display. A single key pad button 64a-64i corresponds to a single menu item choice 62a-62i. As further illustrated, a portion of the display area of the video display 26 may be dedicated to the static or rolling display of advertisements 66 which may consist of paid advertisements as a form of revenue generation for the golf course.

With reference now to FIG. 5, there is a diagrammatic illustration of the menu kiosk terminal 12 supported and house by decorative housing 38 that is illustrated here as a simulative boulder. Of course the decorative housing 68 may be constructed as various other forms as desired and should not be limited solely to a simulative boulder. Housing 68 protects the menu kiosk terminal 12 against the elements and permits user access to both the video display screen 26 and the key pad.

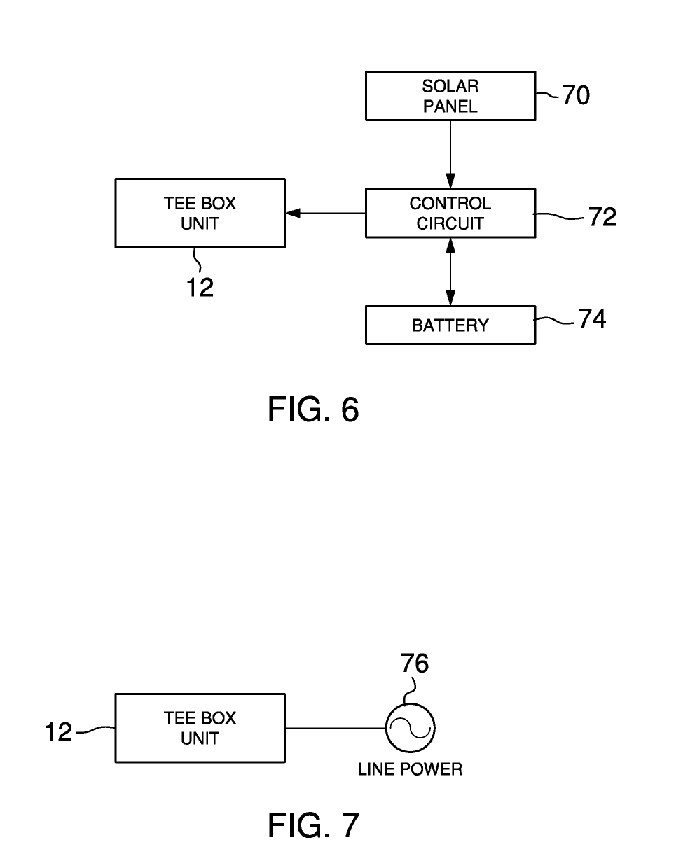

Turning now to FIG. 6, there is schematically illustrated one power scheme in which the menu kiosk terminal 12 is electrically powered by an electric power source comprising a solar panel array 70, a control circuit 72 and a rechargeable electrical energy storage device such as a battery array 74. The solar panel array 70 is operatively connected to the control circuit 72 to transmit electrical energy produced by the solar panel array to the control circuit. The menu kiosk terminal 12 is operatively connected to the control circuit 72 to receive electrical energy produced by the solar panel array 70 for operating the menu kiosk. The battery array 74 is operatively connected to the control circuit 72 to receive and store excess electrical energy produced by the solar panel array 70 and to provide electrical energy to the menu kiosk terminal 12 during periods when the solar panel array is not producing a sufficient amount of electrical energy required to operate the menu kiosk. The control circuit 72 is configured for the automated switching of the flow of electrical energy from and to the battery array 74 as required. Alternatively, the menu kiosk terminal 12 may be connected to line power 76 for operation as schematically shown in FIG. 7.

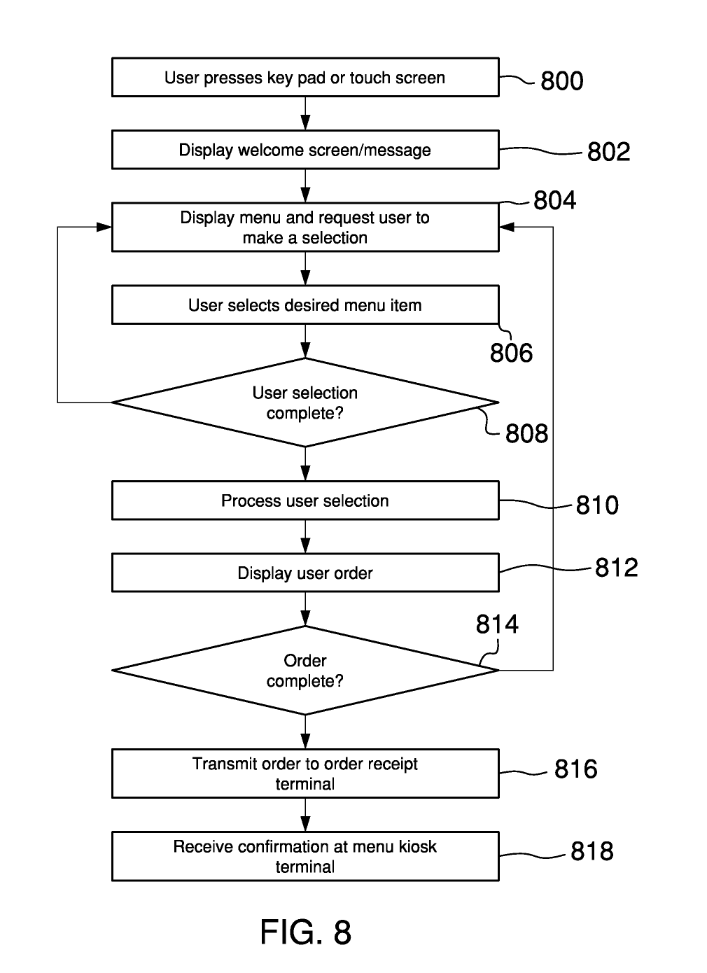

With further reference to FIG. 8 and at step 800, a golfer/user approaches the menu kiosk terminal 12 and presses either the video display 26 or the key pad 28 to wake-up the menu kiosk terminal from a power-saving sleep mode. At step 802, a welcome screen is displayed on video display 26 which may include hospitality specials, advertisements, instructions, etc. At step 804, a menu having various menu item selections are displayed on the video display 26. Instructions may also be displayed on the video display and/or sounded by sound module 36 to the user.

At step 806, the user by either pressing the video display 26 or key pad 28 makes a selection from the displayed menu. The selection may be for a category of food and/or beverage items, wherein then additional menu item selections are displayed or the selection may be for a specific menu item. In an embodiment, the main menu screen will comprise category selections for various food and/or beverage, e.g. the main menu screen may include category selections such as sandwiches, burgers, soups, fruit, snacks, beer, coolers, coffee/tea, beverages, etc. More or less or alternative category selections may be provided. Once pressing or selecting a category selection, a sub-menu is displayed which includes the various menu offerings based upon the category selection.

At step 808, it is determined if user selection is completed. For example, a prompt may be displayed to the user requesting the user to input an answer to a question regarding the user's selection. If it is determined the user is not finished with his or her selection the process returns to step 804 for additional menu item selections. If it is determined the user has finished his or her menu selections, the process proceeds to step 810.

At step 810, the menu kiosk terminal 12 processes the user's menu selections and compiles an order comprising each menu selection. The order is then displayed to the user at step 812. At step 814, it is determined if user's order is complete and accurate. For example, a prompt may be displayed to the user requesting the user to input an answer to a question regarding the user's order. If it is determined the order is not correct, or the user desires to modify the order user the process returns to step 804 for additional menu item selections. If it is determined the order is complete, the process proceeds to step 816.

At step 816, the completed order is transmitted by the transceiver 32 over communication network 22 by the menu kiosk terminal 12 to the order receipt terminal 14. At the order receipt terminal 14, the transmitted order is received by transceiver 46 and processed to errors. At step 818, a received order confirmation is received by the menu kiosk 12 from the order receipt kiosk 14 and an associated indication is displayed on video display 26, sounded by sound module 36 or a combination of both to the user, thereby assuring to the user that the order was received and is being processed. The user then proceeds to continue his or her play.

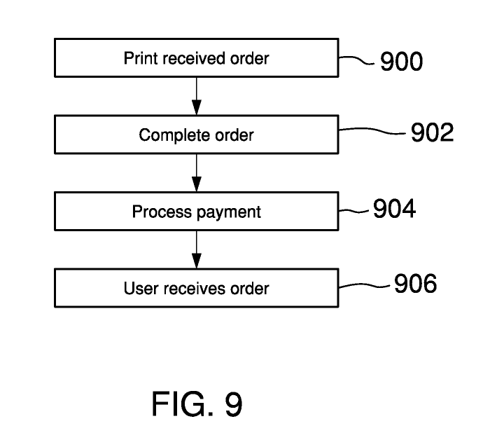

With further reference to FIG. 9 and at step 900, at the order receipt terminal 14 the received order is printed by printer 54 and optionally or alternatively, the received order is displayed on a video display (not shown) and/or sounded by a sound module (not shown).

At step 902, employees of the hospitality facility 20 completes the received order and packages the order to be received by the user once the user has completed play of the particular hole. At step 904, the user visits the hospitality facility 20 and pays for the ordered food and/or beverage that was ordered using the menu kiosk terminal 12. A step 906, the user receives his or her order, leaves the hospitality facility 20 and continues play of his or her round of golf. The result is improved food quality and increased speed of play on the golf course.

A number of embodiments of the present invention have been described. Nevertheless, it will be understood that various modifications may be made without departing from the spirit and scope of the invention. Accordingly, other embodiments are within the scope of the following claims.

What is claimed is:

1. A golf course foodstuff ordering system, comprising:
a menu kiosk located on a golf course at a location remotely from a food facility located on the golf course;
an order receipt unit located at the food facility;
said menu kiosk including a means for displaying menu items offered by the food facility, a means for receiving a menu item selection from a user, a means for generating a foodstuff order including one or more menu item selections, and a means for transmitting said foodstuff order; and
said order receipt unit including a means for receiving from said menu kiosk said order and a means for printing said order at the food facility.

2. The golf course foodstuff ordering system of claim 1, wherein said menu kiosk is located at a tee box.

3. The golf course foodstuff ordering system of claim 1, wherein said means for displaying menu items displays menu items based upon a previous menu item selection.

4. The golf course foodstuff ordering system of claim 1, wherein said menu kiosk further includes a means for displaying an advertisement.

5. A method of order foodstuff at a golf course, the method comprising the steps of:
displaying a menu at a menu kiosk that is located on the golf course at a location that is remote from a food facility of the golf course, said menu including one or more menu items;
receiving one or more menu item selections by said menu kiosk;
generating a foodstuff order including said one or more selected menu items;
transmitting said foodstuff order over a communication network from said menu kiosk to an order receipt unit located at the food facility;
receiving said foodstuff order from said menu kiosk by said order receipt unit;
printing said foodstuff order;
processing said foodstuff order in a time period that permits receipt of said one or more menu item selections subsequent completion of play of a designated golf hole of said golf course.

6. The method of claim 5, wherein said menu kiosk is located at a tee box on the golf course.

7. The method of claim 5, wherein during the displaying step:
said menu is displayed upon a touch screen display and comprises a graphical user interface from which said one or more menu items may be selected.

8. The method of claim 5, wherein said communication network is selected from TCP/IP, cellular and radio frequency.

9. A method of order foodstuff at a golf course, the method comprising the steps of:
displaying a menu by a menu displaying means of a menu kiosk that is located on the golf course at a location that is remote from a food facility of the golf course, said menu including one or more menu items;
receiving one or more menu item selections by a means for receiving menu item selections of said menu kiosk;
generating a foodstuff order including said one or more menu item selections by a means for generating a foodstuff order of said menu kiosk;
transmitting said foodstuff order over a communication network from said menu kiosk to an order receipt unit located at the food facility;
receiving said foodstuff order over said communication network by an order receiving means of said order receipt unit and from said menu kiosk;
printing said foodstuff order by a printing means for printing a foodstuff order of said order receipt unit; and
processing said foodstuff order in a time period that permits receipt of said one or more menu item selections subsequent completion of play of a designated golf hole of said golf course.

10. The method of claim 9, wherein said menu kiosk is located at a tee box on the golf course.

11. The method of claim 9, wherein during the displaying step:
said menu is displayed upon a touch screen display and comprises a graphical user interface from which said one or more menu items may be selected.

12. The method of claim 9, wherein said communication network is selected from TCP/IP, cellular and radio frequency.
